(19) United States
(12) Patent Application Publication
(10) Pub. No.: US 2020/0284232 A1
(43) Pub. Date: Sep. 10, 2020

(54) FUEL SUPPLY STRUCTURE OF INTERNAL COMBUSTION ENGINE

(71) Applicant: HONDA MOTOR CO., LTD., Tokyo (JP)

(72) Inventors: Tetsuji Furukawa, Wako-shi (JP); Hiromasa Iida, Wako-shi (JP)

(73) Assignee: HONDA MOTOR CO., LTD., Tokyo (JP)

(21) Appl. No.: 16/787,419

(22) Filed: Feb. 11, 2020

(30) Foreign Application Priority Data
Mar. 6, 2019 (JP) 2019-040388

(51) Int. Cl. F02M 69/46

(52) U.S. Cl. CPC F02M 69/462

(57) ABSTRACT

An internal combustion engine includes a delivery pipe through which a fuel is supplied to a fuel injection valve, a high-pressure fuel passage connected to the upstream side of the delivery pipe, and a high-pressure fuel pump connected to the upstream side of the high-pressure fuel passage. At least two narrowed-passage sections are disposed in the delivery pipe or the high-pressure fuel passage.

### CROSS REFERENCES TO RELATED APPLICATIONS

The present application claims priority under 35 U.S.C. § 119 to Japanese Patent Application No. 2019-040388, filed Mar. 6, 2019, entitled “FUEL SUPPLY STRUCTURE OF INTERNAL COMBUSTION ENGINE.” The contents of this application are incorporated herein by reference in their entirety.

### BACKGROUND

### 1. Field

The present application relates to a fuel supply structure of an internal combustion engine including a delivery pipe through which a fuel is supplied to a fuel injection valve, a high-pressure fuel passage connected to the upstream side of the delivery pipe, and a high-pressure fuel pump connected to the upstream side of the high-pressure fuel passage, in which at least two passage narrowed portions are disposed in the delivery pipe or the high-pressure fuel passage.

### 2. Description of the Related Art

According to Japanese Unexamined Patent Application Publication No. 2007-154850, there is a publicly known technology in which a first orifice is disposed in each of bifurcated tandem pipes connected to the upstream side of a pair of delivery pipes of a V-type internal combustion engine and a second orifice is disposed in a loop pipe connecting the downstream sides of the pair of delivery pipes to each other, the second orifice having an orifice diameter smaller than the orifice diameter of the first orifice to thereby reduce pulsation of fuel pressure along with fuel injection from the fuel injection valve.

As described in Japanese Unexamined Patent Application Publication No. 2007-154850, when a passage narrowed portion is disposed in a high-pressure fuel passage on the upstream of a delivery pipe, pulsation of fuel pressure along with a fuel injection from a fuel injection valve can be reduced. There is, however, a possibility that an abnormal high pressure occurs in the fuel pressure in the high-pressure fuel passage on the upstream side of the delivery pipe when strong water hammering has occurred due to abnormality of the fuel injection valve and the deliver pipe.

### SUMMARY

The present application describes suppression of an abnormal increase of fuel pressure that occurs in a high-pressure fuel passage on the upstream of the delivery pipe.

To achieve the above, a first aspect of the present application proposes a fuel supply structure of an internal combustion engine including a delivery pipe through which a fuel is supplied to a fuel injection valve, a high-pressure fuel passage connected to the upstream side of the delivery pipe, and a high-pressure fuel pump connected to the upstream side of the high-pressure fuel passage, in which at least two narrowed-path/passage sections are disposed in the delivery pipe or the high-pressure fuel passage and in which the diameter of one of the narrowed-passage sections positioned on the upstream side and a diameter of one of the narrowed-passage sections positioned on the downstream side differ from each other. Even when an abnormal increase in fuel pressure is caused in the fuel injection valve and the delivery pipe by water hammering along with abnormality, due to the diameter of the narrowed-passage section positioned on the upstream side and the diameter of the narrowed-passage section positioned on the downstream side differing from each other, the abnormal increase in the fuel pressure can be effectively reduced by the narrowed portions. Each of the narrowed-passage section may be a pipe like structure with a smaller diameter than their corresponding upstream main path effectively to absorb pressure change and dump pressure pulsation which may occur in the fuel path due to a rapid pressure reduction when the fuel is discharged from the delivery pipes.

A second aspect of the present application proposes a fuel supply structure of an internal combustion engine having the configuration of the first aspect, in which the diameter of the one of the narrowed-passage sections positioned on the upstream side may be larger than the diameter of the one of the narrowed-passage sections positioned on the downstream side. Consequently, an abnormal increase in fuel pressure caused by water hammering along with abnormality of the fuel injection valve and the delivery pipe may be more effectively reduced by the small-diameter narrowed-passage section near a source of the water hammering.

A third aspect of the present application proposes a fuel supply structure of an internal combustion engine having the configuration of the first aspect, in which the high-pressure fuel pump may include a relief valve connected to a low-pressure fuel passage. Consequently, it may be possible to prevent damage of the relief valve caused by a pressure difference between a low pressure of the low-pressure fuel passage and an abnormal high pressure caused by water hammering along with abnormality of the fuel injection valve and the delivery pipe.

Note that an upstream-side high-pressure fuel passage 15 and a downstream-side high-pressure fuel passages 17 in an embodiment correspond to the high-pressure fuel passage of the present application.

### BRIEF DESCRIPTION OF THE DRAWINGS

FIG. 1 is a perspective view of a fuel passage of an internal combustion engine.

FIG. 2 is a circuit diagram of the fuel passage of the internal combustion engine.

FIG. 3 is a single article figure of a high-pressure fuel passage.

FIGS. 4A and 4B are a sectional view taken along line IVA-IVA of FIG. 3 and a sectional view taken along line IVB-IVB of FIG. 3.

FIG. 5 is a graph indicating a relation of a peak value of fuel pressure pulsation to the diameter of an upstream-side narrowed-passage section.

### DESCRIPTION OF THE PREFERRED EMBODIMENTS

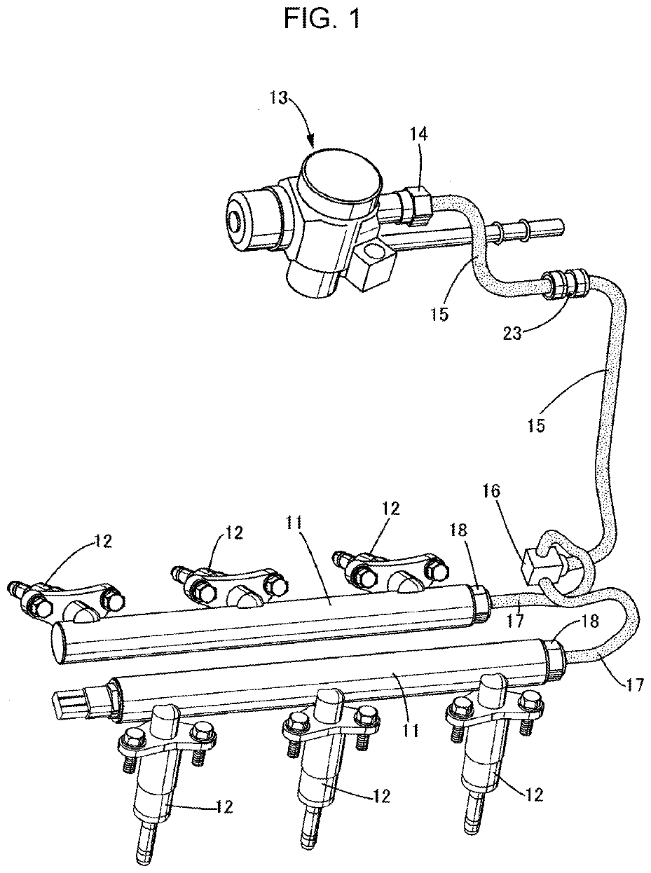

Hereinafter, an embodiment of the present application will be described on the basis of FIG. 1 to FIG. 5.

FIG. 1 illustrates a fuel supply apparatus of a V-type 6-cylinder internal combustion engine. A pair of delivery pipes 11 are disposed along a pair of banks of the internal combustion engine, and three fuel injection valves 12 are connected to each of the delivery pipes 11. An upstream-side high-pressure fuel passage 15 is connected, via a joint 14, to a discharge port of a high-pressure fuel pump 13 including a plunger pump that is driven by a cam shaft of the internal combustion engine. The downstream end of the upstream-side high-pressure fuel passage 15 branches, via a joint 16, into a pair of downstream-side high-pressure fuel passages 17. The pair of downstream-side high-pressure fuel passages 17 are connected, via a corresponding one of joints 18, to a corresponding one of the pair of delivery pipes 11.

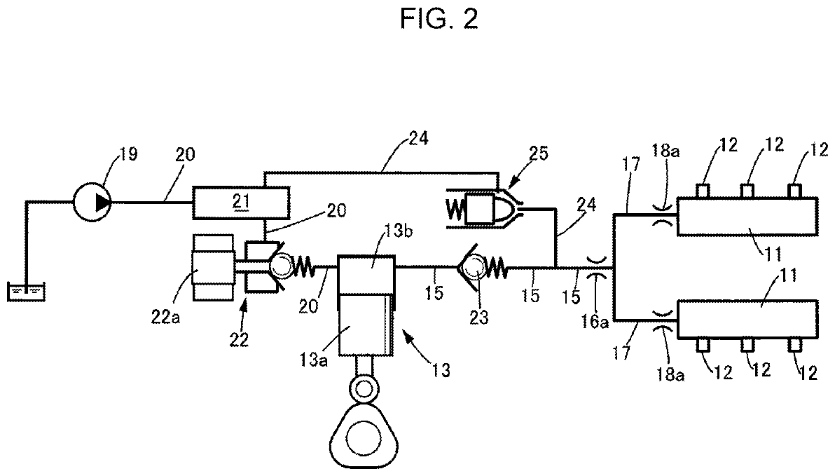

As illustrated in FIG. 1 and FIG. 2, a discharge port of a low-pressure fuel pump 19 that pumps a fuel from an oil pan of the internal combustion engine is connected, via a low-pressure fuel passage 20, to an intake port of the high-pressure fuel pump 13. On the upstream side and the downstream side of the low-pressure fuel passage 20, a pulsation damper 21 and an electromagnetic check valve 22 are disposed, respectively. The pulsation damper 21 includes a space portion having a predetermined capacity and damps pressure pulsation of the low-pressure fuel passage 20. The electromagnetic check valve 22 constitutes an intake valve that allows a fuel to flow into the high-pressure fuel pump 13 and that obstructs the fuel from flowing out from the high-pressure fuel pump 13. Valve-closing timing can be controlled by energizing a solenoid 22a of the electromagnetic check valve 22. In addition, in the upstream-side high-pressure fuel passage 15, a check valve 23 that allows a fuel to flow out from the high-pressure fuel pump 13 and that obstructs the fuel from flowing into the high-pressure fuel pump 13 is disposed. The check valve 23 constitutes a discharge valve of the high-pressure fuel pump 13.

Further, a relief valve 25 is disposed in a return passage 24 connecting the upstream-side high-pressure fuel passage 15 on the downstream side of the check valve 23 and the pulsation damper 21 to each other. The relief valve 25 opens when an abnormal high pressure occurs in the upstream-side high-pressure fuel passage 15 on the downstream of the check valve 23, the downstream-side high-pressure fuel passages 17, and the delivery pipes 11 to enable the high pressure to be released into the pulsation damper 21.

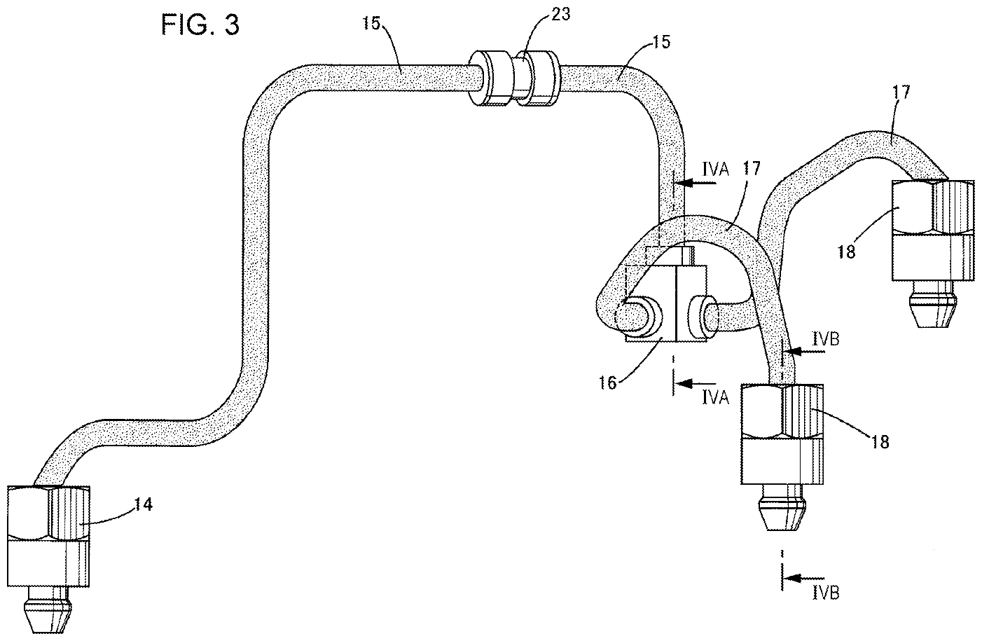

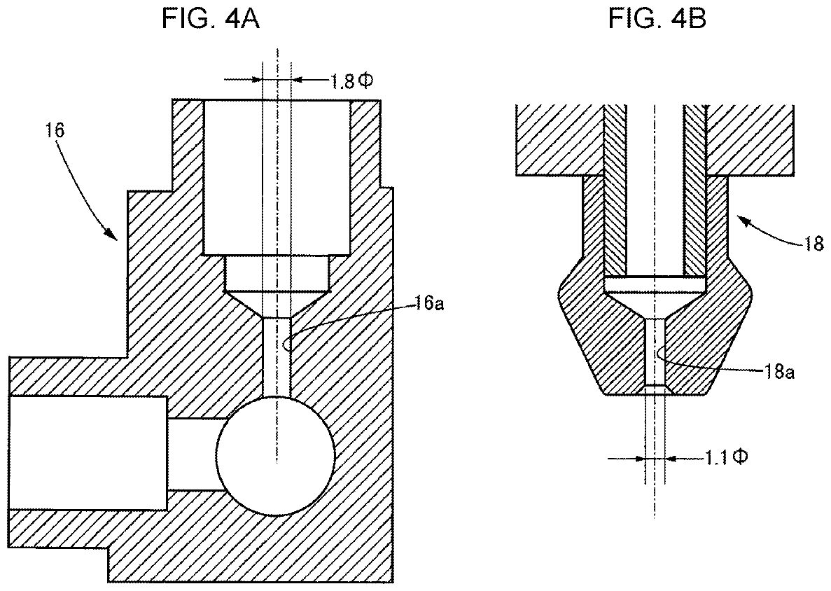

As illustrated in FIG. 3 and FIGS. 4A and 4B, the upstream ends of the pair of downstream-side high-pressure fuel passages 17 are connected, via the joint 16, to the downstream end of the upstream-side high-pressure fuel passage 15. A narrowed-passage section 16a is disposed in an inner portion of the joint 16. Narrowed-passage sections 18a are disposed in a corresponding one of the joints 18 at the downstream ends of the pair of downstream-side high-pressure fuel passages 17. The inner diameter of the narrowed-passage section 16a, which is on the upstream side, disposed in the joint 16 is, for example, 1.8 mm. The inner diameter of the narrowed-passage sections 18a, which are on the downstream side, disposed in the joints 18 is, for example, 1.1 mm. The diameter of the narrowed-passage section 16a on the upstream side is set to be larger than the diameter of the narrowed-passage sections 18a on the downstream side.

Next, an operation of an embodiment of the present application provided with the aforementioned configuration will be described.

Referring to FIG. 2, when the capacity of a pump chamber 13b is increased as a result of a plunger 13a of the high-pressure fuel pump 13 that is driven by the cam shaft of the internal combustion engine withdrawing, the check valve 23 of the upstream-side high-pressure fuel passage 15 closes and the electromagnetic check valve 22 of the low-pressure fuel passage 20 opens. Consequently, a fuel is taken into the pump chamber 13b. Subsequently, when the capacity of the pump chamber 13b is decreased as a result of the plunger 13a advancing, the electromagnetic check valve 22 closes and the check valve 23 opens. Consequently, the fuel in the pump chamber 13b is sent to the upstream-side high-pressure fuel passage 15 by pressure. At this time, the discharging pressure of the high-pressure fuel pump 13 can be freely adjusted by delaying the valve-closing timing by a predetermined period of time through energization of the solenoid 22a concurrently with the advancing of the plunger 13a without closing the electromagnetic check valve 22. Along with the opening/closing of the electromagnetic check valve 22, the fuel pressure in the low-pressure fuel passage 20 on the upstream side pulsates. The pulsation of the fuel pressure is, however, reduced by the pulsation damper 21.

The high-pressure fuel supplied into the upstream-side high-pressure fuel passage 15 is supplied into the pair of delivery pipes 11 via the pair of downstream-side high-pressure fuel passages 17 that are branched from each other at the joint 16 into a bifurcated shape. The high-pressure fuel is then injected from the fuel injection valves 12 into corresponding cylinders. When one of the fuel injection valves 12 injects the fuel, the fuel pressure in the delivery pipes 11 suddenly decreases, and pulsation occurs in the delivery pipes 11, the downstream-side high-pressure fuel passages 17, and the upstream-side high-pressure fuel passage 15. The pressure pulsation is, however, damped by the three narrowed-passage sections 16a and 18a disposed in the upstream-side high-pressure fuel passage 15 and the downstream-side high-pressure fuel passages 17. The fuel injection valves 12 of the pair of delivery pipes 11 inject the fuel alternately. Thus, a pressure difference is generated between the fuel pressures in the pair of delivery pipes 11. The two narrowed-passage sections 18a disposed in the downstream-side high-pressure fuel passages 17 exert a function of reducing the pressure difference.

When, for some reasons, abnormality occurs in the fuel injection valves 12 and the delivery pipes 11 and an abnormal high pressure due to water hammering has occurred in the fuel pressure in the delivery pipes 11, the downstream-side high-pressure fuel passages 17, and the upstream-side high-pressure fuel passage 15, the relief valve 25 disposed in the return passage 24 opens to release the abnormal high pressure to the pulsation damper 21 of the low-pressure fuel passage 20, thereby preventing the fuel injection valves 12 and the delivery pipes 11 from being damaged.

In the present embodiment, the downstream side of the relief valve 25 is not connected to the upstream-side high-pressure fuel passage 15 having a high pressure and is connected to the pulsation damper 21 having a low pressure. The relief valve 25 thus easily opens due to a large pressure difference between the upstream side having a high pressure and the downstream side having a low pressure. The relief valve 25 is, however, non-reusable when once opened and is required to be replaced. It is thus not desirable that the relief valve 25 open without good reason. For such a reason, it is preferable to cause, when an abnormal pressure has occurred in the fuel injection valves 12 and the delivery pipes 11, the abnormal high pressure not to easily act on the upstream side of the relief valve 25.

In the present embodiment, the diameter of the narrowed-passage section 16a on the upstream side is set to be larger than the diameter of the narrowed-passage sections 18a on the downstream side. The abnormal high pressure that has occurred in the fuel injection valves 12 and the delivery pipes 11 is thus damped by the small-diameter narrowed-passage sections 18a disposed immediately upstream thereof. Consequently, the relief valve 25 disposed in the return passage 24 is reliably prevented from opening without good reason.

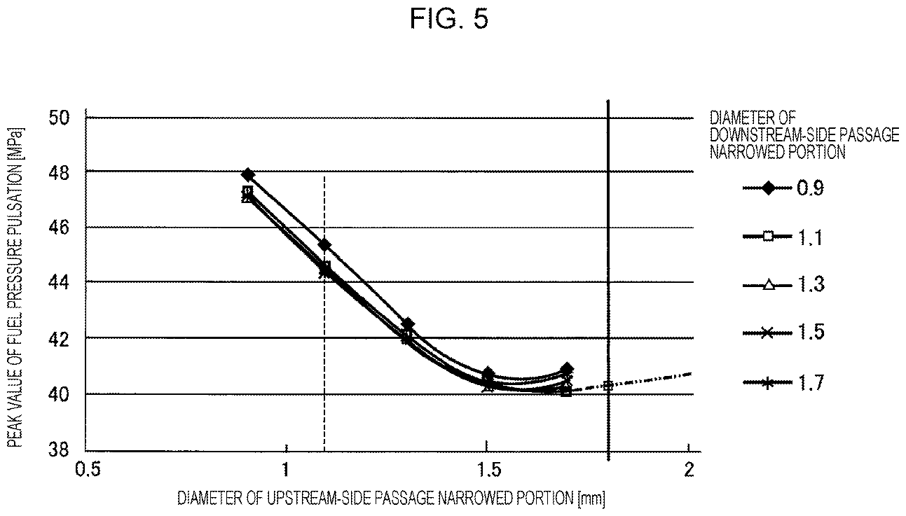

In the graph in FIG. 5, a peak value of fuel pressure pulsation relative to the diameter of the narrowed-passage section 16a on the upstream side is shown for various diameters of the narrowed-passage sections 18a on the downstream side.

The graph demonstrates that an increase of the diameter of the narrowed-passage section 16a on the upstream side gradually decreases the peak value of the fuel pressure pulsation. The peak value of the fuel pressure pulsation is the smallest when the diameter is approximately 1.6 mm. The peak value then increases constantly or slowly. This characteristic is substantially constant regardless of the diameter of the narrowed-passage sections 18a on the downstream side. For such a reason, in the present embodiment, the diameter of the narrowed-passage section 16a on the upstream side is set to 1.8 mm, and the diameter of the narrowed-passage sections 18a on the downstream side is set to 1.1 mm. It is, however, considered that fuel pressure pulsation can be reduced by setting the diameter of the narrowed-passage section 16a on the upstream side to be large with respect to the diameter of the narrowed-passage sections 18a on the downstream side.

An embodiment of the present application has been described above; however, various design changes can be applied to the present application within the range of the gist of the present application.

For example, an internal combustion engine to which the present application is applied is not limited to the V-type 6-cylinder internal combustion engine as with the embodiment and may be a V-type internal combustion engine with a different number of cylinders or an inline internal combustion engine with a predetermined number of cylinders.

The number of the narrowed-passage sections is not limited to three as with the embodiment and may be at least two including the narrowed-passage section 16a positioned on the upstream side and the narrowed-passage section 18a positioned on the downstream side.

The locations where the narrowed-passage sections are disposed are not limited to the upstream-side high-pressure fuel passage 15 and the downstream-side high-pressure fuel passages 17 and may be the delivery pipes 11.

What is claimed is:

1. A fuel supply structure of an internal combustion engine comprising:
a delivery pipe through which a fuel is supplied to a fuel injection valve;
a high-pressure fuel passage connected to an upstream side of the delivery pipe; and
a high-pressure fuel pump connected to an upstream side of the high-pressure fuel passage,
wherein at least two narrowed-passage sections are formed in the delivery pipe or the high-pressure fuel passage, one of the narrowed-passage sections being positioned on an upstream side of another one of the narrowed-passage sections, and
wherein a diameter of the one of the narrowed-passage sections positioned on the upstream side differs from a diameter of the another one of the narrowed-passage sections positioned on a downstream side.

2. The fuel supply structure of the internal combustion engine according to claim 1,
wherein the diameter of the one of the narrowed-passage sections positioned on the upstream side is larger than the diameter of the another one of the narrowed-passage sections positioned on the downstream side.

3. The fuel supply structure of the internal combustion engine according to claim 1, further comprising a low-pressure fuel passage,
wherein the high-pressure fuel pump has a relief valve connected to the low-pressure fuel passage.
